(19) United States
(12) Patent Application Publication
(10) Pub. No.: US 2024/0159140 A1
(43) Pub. Date: May 16, 2024

(54) Iterative Cement Bond Logging Without Calibration

(71) Applicant: Halliburton Energy Services, Inc., Houston, TX (US)

(72) Inventors: Jiajun Zhao, Houston, TX (US); Ruijia Wang, Singapore (SG); Brenda Sue Jonathan, Jompol (TH)

(73) Assignee: Halliburton Energy Services, Inc., Houston, TX (US)

(21) Appl. No.: 18/484,140

(22) Filed: Oct. 10, 2023

Related U.S. Application Data
(60) Provisional application No. 63/421,294, filed on Nov. 1, 2022.

(51) Int. Cl. E21B 47/005; G01N 29/11

(52) U.S. Cl. CPC E21B 47/005; G01N 29/11; G01N 2291/0232

(57) ABSTRACT

In general, in one aspect, embodiments relate to a method that includes disposing a bottom hole assembly (BHA) into a wellbore at a depth, where the BHA includes at least one transmitter configured to transmit an acoustic waveform into at least a casing, and at least one receiver. Herein the method may further comprise recording one or more casing waveforms that originate from within or behind the casing, calculating at least two or more downhole parameters with the one or more casing waveforms, calculating a correlation coefficient between the at least two or more downhole parameters, and forming a cement bond log based at least in part on the correlation coefficient.

### CROSS REFERENCE TO RELATED APPLICATIONS

This application claims the priority of U.S. Provisional Patent Application No. 63/421,294, filed Nov. 1, 2022, which is incorporated by reference in its entirety.

### BACKGROUND

For oil and gas exploration and production, a network of wells, installations and other conduits may be established by connecting sections of metal pipe together. For example, a well installation may be completed, in part, by lowering multiple sections of metal pipe (i.e., a conduit string) into a wellbore, and cementing the conduit string in place. In some well installations, layers of conduit strings may be employed (e.g., a concentric multi-string arrangement) to allow for different operations related to well completion, production, or enhanced oil recovery (EOR) options. Pumping cement into the annulus between casing and formation or between two casings after drilling, is a key step of well completion and to keep formation integrity.

For cementing quality control, it is necessary to quantitatively measure the bonding condition at the interfaces between casing and cement. For example, at the end of a well installations' life, the well installation may be plugged and abandoned. Understanding cement bond integrity to a conduit string may be beneficial in determining how to plug the well installation. Additionally, production operations require precise knowledge of cement bond integrity. If erosion or poor bonding is present operations to repair the cement may be performed. Cement bonding logging (CBL) plays an important role in determining well integrity, to ensure zonal isolation in a wellbore. Generally, sonics may be implemented by sonic tools to form CBLs.

CBL has recently evolved to include logging-while-drilling (LWD) sonic tools due to the multiple benefits of LWD logging, including reduced tool decentering effects, tool conveyance, and time lapse evaluation, etc. Yet, there is an LWD-specific challenge, which is the contamination of the casing mode by the drill collar mode. Specifically, tool waves traveling along LWD tools appear in the first echo of casing arrivals, and their amplitudes could be much larger than casing wave arrivals. Consequently, the estimates of casing wave amplitudes are biased due to the involvement of tool wave amplitudes if using conventional CBL processing. Additionally, the estimates of casing wave attenuations suffer from the existence of tool wave arrivals because the relation between attenuation and cement bond indices is no longer monotonic. This non-monotonic relation results in the non-uniqueness of solutions.

To resolve the tool wave contamination issue, one approach based on first-echo amplitudes is to correct the amplitudes so that unbiased casing wave amplitudes can be obtained. Such method is sensitive to the estimated tool wave amplitudes. The other approach based on a hybrid of amplitude and attenuation information is to combine amplitude-based and attenuation-based techniques for full-range CBL. However, both approaches require calibration based on the information of 100% bond zones or free pipe zones. This calibration step involves human intervention and could pose a hinderance to accurate CBL if the regions of 100% bond zones or free pipe zones cannot be correctly identified. Additionally, it may be difficult to determine 100% bond zones or free pipe zones.

### BRIEF DESCRIPTION OF THE DRAWINGS

These drawings illustrate certain aspects of some examples of the present disclosure and should not be used to limit or define the disclosure.

FIG. 1 illustrates a well during drilling operations;

FIG. 2 illustrates a sonic measurement operation using measurement assembly;

FIG. 3 illustrates a pre-processing workflow;

FIG. 4 illustrates s workflow for iterating a cement bond log;

FIG. 5 illustrates a graph that shows a summation model;

FIG. 6A illustrates an example of a root mean square amplitude for a receiver;

FIG. 6B illustrates RealAtt log converted into a cement bond index;

FIG. 6C illustrates magnitude at the first receiver RX1;

FIG. 6D illustrates apparent attenuation at the last receiver AppAtt;

FIG. 6E illustrates apparent attenuation difference between the 2nd and the last receiver delta AppAtt;

FIG. 6F is a graph that illustrates initial branch indicator for the entire depth range;

FIG. 7A illustrates an example of a root mean square amplitude for a receiver after a correlation coefficient is minimized;

FIG. 7B illustrates real attenuation RealAtt log converted into a cement bond index after a correlation coefficient is minimized;

FIG. 7C illustrates magnitude at the first receiver RX1 after a correlation coefficient is minimized;

FIG. 7D illustrates apparent attenuation at the last receiver AppAtt after a correlation coefficient is minimized;

FIG. 7E illustrates apparent attenuation difference between the 2nd and the last receiver delta AppAtt after a correlation coefficient is minimized;

FIG. 7F is a graph that illustrates initial branch indicator for the entire depth range after a correlation coefficient is minimized;

FIG. 8 illustrates an example information handling system;

FIG. 9 illustrates another example information handling system; and

FIG. 10 illustrates an example of one arrangement of resources in a computing network.

### DETAILED DESCRIPTION

Methods and systems herein may generally disclose automated processing of iterative cement bond logging using a logging while drilling (LWD) tool. Methods and systems herein may disclose the utilizing of attenuation measurements along a receiver array and relative amplitude measurements. As such, improvements over current technology may be iteratively based rather than calibration based on identification of 100% bond zones or free pipe zones. Herein iteratively may at least in part be defined as optimizing attenuation inversion and an inversion model. In examples, attenuation inversion and the inversion model may be defined as a summation model. In examples, methods and systems may be designed for post-processing LWD cement bond logs (CBL). In further examples, systems and methods may be applicable to on-side and real-time processing.

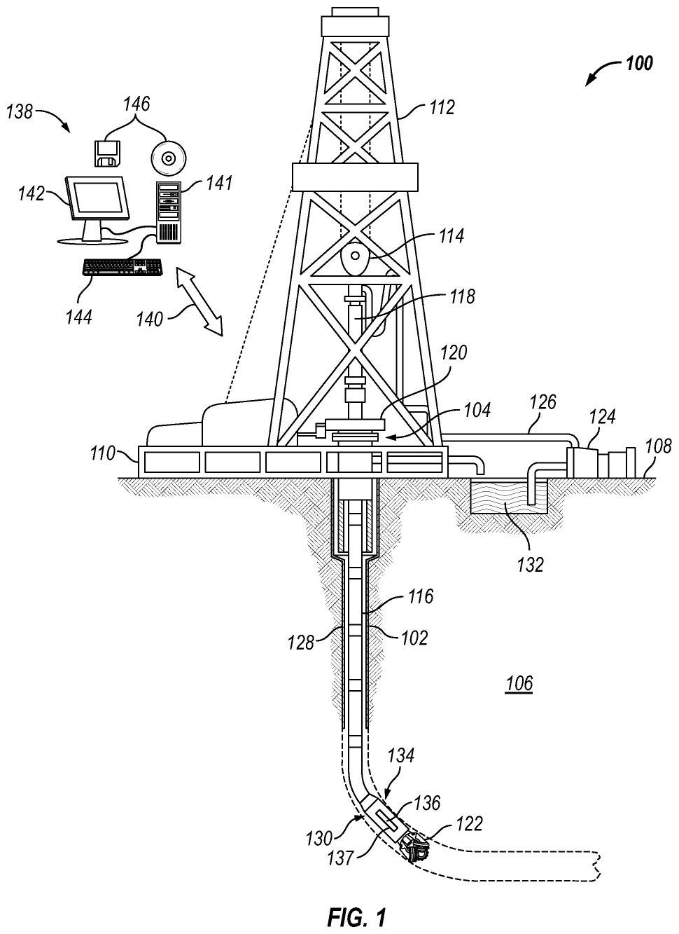

FIG. 1 illustrates a drilling system 100. As illustrated, wellbore 102 may extend from a wellhead 104 into a subterranean formation 106 from a surface 108. Generally, wellbore 102 may include horizontal, vertical, slanted, curved, and other types of wellbore geometries and orientations. Wellbore 102 may be cased or uncased. In examples, wellbore 102 may include a metallic member. By way of example, the metallic member may be a casing, liner, tubing, or other elongated steel casing disposed in wellbore 102.

As illustrated, wellbore 102 may extend through subterranean formation 106. As illustrated in FIG. 1, wellbore 102 may extend generally vertically into the subterranean formation 106, however wellbore 102 may extend at an angle through subterranean formation 106, such as horizontal and slanted wellbores. For example, although FIG. 1 illustrates a vertical or low inclination angle well, high inclination angle or horizontal placement of the well and equipment may be possible. It should further be noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor and/or via rotation of drill string 116 from surface 108. Without limitation, drill bit 122 may comprise roller cone bits, PDC bits, natural diamond bits, any hole openers, reamers, coring bits, and the like. As drill bit 122 rotates, it may create and extend wellbore 102 that penetrates various subterranean formations 106. A pump 124 may circulate drilling fluid through a feed pipe 126 through kelly 118, downhole through interior of drill string 116, through orifices in drill bit 122, back to surface 108 via annulus 128 surrounding drill string 116, and into a retention pit 132.

With continued reference to FIG. 1, drill string 116 may begin at wellhead 104 and may traverse wellbore 102. Drill bit 122 may be attached to a distal end of drill string 116 and may be driven, for example, either by a downhole motor and/or via rotation of drill string 116 from surface 108. Drill bit 122 may be a part of bottom hole assembly (BHA) 130 at distal end of drill string 116. BHA 130 may further include tools for look-ahead resistivity applications. As will be appreciated by those of ordinary skill in the art, BHA 130 may be a measurement-while drilling (MWD) or logging-while-drilling (LWD) system.

BHA 130 may comprise any number of tools, transmitters, and/or receivers to perform downhole measurement operations. For example, as illustrated in FIG. 1, BHA 130 may include a measurement assembly 134. It should be noted that measurement assembly 134 may make up at least a part of BHA 130. Without limitation, any number of different measurement assemblies, communication assemblies, battery assemblies, and/or the like may form BHA 130 with measurement assembly 134. Additionally, measurement assembly 134 may form BHA 130 itself. In examples, measurement assembly 134 may comprise at least one transmitter 136 and at least one receiver 137. Transmitter 136 may be an acoustic source that transmits pressure pulses, i.e., acoustic waveforms, into casing 200, cement 204, and subterranean formation 106. Receiver 137 may operate and function to record any number of acoustic waveforms, such as pressure pulses that may have reflected off subterranean formation 106 (i.e., an echo), come from tools used in drilling operations, drilling operation noise, direct coupling from transmitter 136, and/or the like. It should be noted that transmitters 136 and receiver 137 may be transducers and in examples may both transmitter 136 and receiver 137 may be the same transducer. Additionally, one or more receivers 137 may be used to form a receiver array, which may record acoustic waveforms over a range of distances. Both transmitter 136 and receiver 137 may be disposed at the surface of measurement assembly 134 and/or may also be disposed within measurement assembly 134. Without limitation, transmitters 136 and receivers 137 may be disposed ninety degrees from each other. However, it should be noted that there may be any number of transmitters 136 and receivers 137 disposed along BHA 130 at any degree from each other. Additionally, transmitters 136 and receivers 137 may be aligned on top of each other and spaced about the axis of BHA 130.

Without limitation, BHA 130 and all parts within BHA 130 (i.e., transmitters 136 and receivers 137) may be connected to and/or controlled by information handling system 138, which may be disposed on surface 108. Without limitation, information handling system 138 may be disposed downhole in BHA 130. Processing of information recorded may occur downhole and/or on surface 108. Processing occurring downhole may be transmitted to surface 108 to be recorded, observed, and/or further analyzed. Additionally, information recorded on information handling system 138 that may be disposed downhole may be stored until BHA 130 may be brought to surface 108. In examples, information handling system 138 may communicate with BHA 130 through a communication line (not illustrated) disposed in (or on) drill string 116. In examples, wireless communication may be used to transmit information back and forth between information handling system 138 and BHA 130. Information handling system 138 may transmit information to BHA 130 and may receive as well as process information recorded by BHA 130. In examples, a downhole information handling system (not illustrated) may include, without limitation, a microprocessor or other suitable circuitry, for estimating, receiving and processing signals from BHA 130. Downhole information handling system (not illustrated) may further include additional components, such as memory, input/output devices, interfaces, and the like. In examples, while not illustrated, BHA 130 may include one or more additional components, such as analog-to-digital converter, filter and amplifier, among others, which may be used to process the measurements of BHA 130 before they may be transmitted to surface 108. Alternatively, raw measurements from BHA 130 may be transmitted to surface 108.

Any suitable technique may be used for transmitting signals from BHA 130 to surface 108, including, but not limited to, wired pipe telemetry, mud-pulse telemetry, acoustic telemetry, and electromagnetic telemetry. While not illustrated, BHA 130 may include a telemetry subassembly that may transmit telemetry data to surface 108. At surface 108, pressure transducers (not shown) may convert the pressure signal into electrical signals for a digitizer (not illustrated). The digitizer may supply a digital form of the telemetry signals to information handling system 138 via a communication link 140, which may be a wired or wireless link. The telemetry data may be analyzed and processed by information handling system 138.

As illustrated, communication link 140 (which may be wired or wireless, for example) may be provided that may transmit data from BHA 130 to an information handling system 138 at surface 108. Information handling system 138 may include a personal computer 141, a video display 142, a keyboard 144 (i.e., other input devices.), and/or non-transitory computer-readable media 146 (e.g., optical disks, magnetic disks) that can store code representative of the methods described herein. In addition to, or in place of processing at surface 108, processing may occur downhole.

Methods and systems may be utilized by information handling system 138 to determine properties of subterranean formation 106. Information may be utilized to produce an image, which may be generated into a two or three-dimensional model of subterranean formation 106. These models may be used for well planning, (e.g., to design a desired path of wellbore 102). Additionally, they may be used for planning the placement of drilling systems within a prescribed area. This may allow for the most efficient drilling operations to reach a subsurface structure. During drilling operations, measurements taken within wellbore 102 may be used to adjust the geometry of wellbore 102 in real time to reach a geological target. Measurements collected from BHA 130 of the formation properties may be used to steer drilling system 100 toward a subterranean formation 106. Additionally, information from measurement assembly 134 may be gathered and/or processed by information handling system 138. For example, signals recorded by receiver 148 may be stored on memory and then processed by information handling system 138.

The processing may be performed real-time during data acquisition or after recovery of BHA 130. For this disclosure, real-time is a duration of time ranging from about a second to about ten minutes. Processing may alternatively occur downhole or may occur both downhole and at surface. Information handling system 138 may process the signals, and the information contained therein may be displayed for an operator to observe and store for future processing and reference. Information handling system 138 may also contain an apparatus for supplying control signals and power to BHA 130.

Systems and methods of the present disclosure may be implemented, at least in part, with information handling system 138. While shown at surface 108, information handling system 138 may also be located at another location, such as remote from wellbore 102. Information handling system 138 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 138 may be a personal computer 141, a network storage device, or any other suitable device and may vary in size, shape, performance, functionality, and price. Information handling system 138 may include random access memory (RAM), one or more processing resources such as a central processing unit (CPU) or hardware or software control logic, ROM, and/or other types of nonvolatile memory. Additional components of the information handling system 138 may include one or more disk drives, one or more network ports for communication with external devices as well as various input and output (I/O) devices, such as a keyboard 144, a mouse, and a video display 142. Information handling system 138 may also include one or more buses operable to transmit communications between the various hardware components. Furthermore, video display 142 may provide an image to a user based on activities performed by personal computer 141. For example, producing images of geological structures created from recorded signals. By way of example, video display unit may produce a plot of depth versus the two cross-axial components of the gravitational field and versus the axial component in borehole coordinates. The same plot may be produced in coordinates fixed to the Earth, such as coordinates directed to the North, East and directly downhole (Vertical) from the point of entry to the borehole. A plot of overall (average) density versus depth in borehole or vertical coordinates may also be provided. A plot of density versus distance and direction from the borehole versus vertical depth may be provided. It should be understood that many other types of plots are possible when the actual position of the measurement point in North, East and Vertical coordinates is taken into account. Additionally, hard copies of the plots may be produced in paper logs for further use.

Alternatively, systems and methods of the present disclosure may be implemented, at least in part, with non-transitory computer-readable media 146. Non-transitory computer-readable media 146 may include any instrumentality or aggregation of instrumentalities that may retain data and/or instructions for a period of time. Non-transitory computer-readable media 146 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

As previously described, information handling system 138 may transmit information to BHA 130 and may receive as well as process information recorded by BHA 130. Without limitation, information from BHA 130 may comprise sonic measurements from one or more transmitters 137.

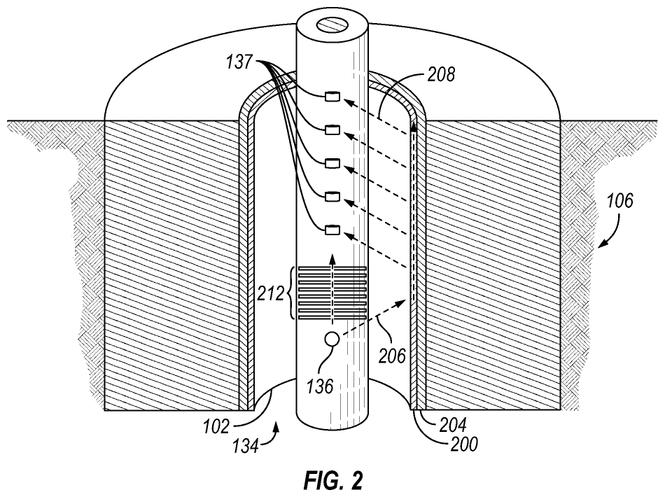

FIG. 2 illustrates a sonic measurement operation using measurement assembly 134 disposed within wellbore 102. As illustrated, wellbore 102 may be formed within subterranean formation 106. Measurement assembly 134 may be separated from subterranean formation 106 by a casing 200, which may be cemented to subterranean formation 106 by cement 204. During operations, casing 200 may be filled with fluid 204, in which measurement assembly 134 may be immersed in. Herein casing 200 may be defined as. . . . During measurement operations a concrete bonding log (CBL) may be formed by information handling system 138 (e.g., referring to FIG. 1) using measurements from measurement assembly 134. To form these logs, during operations, transmitter 136 may emit acoustic waveforms 206 into wellbore 102. In examples, acoustic waveforms 206 may at least partially generate into casing waveforms 208 that traverse casing 200 in any direction. Casing waveforms 208 may be captured and/or measured by one or more 137. One or more receivers 137 may transmit the data from the captured and/or measured casing waveforms to information handling system 138 for further processing using the methods and systems described above. Information handling system 138 may utilize the data from receivers 137 to evaluate bonding condition between casing 200 and material behind casing 200 to form a CBL. For example, evaluated data may show cement 202 fully or partially bonded to casing 200 between casing 200 and subterranean formation 106, fluid 204 between casing 200 and subterranean formation 106, and/or subterranean formation 106 behind casing 200.

During measurement operations, transmitter 136 may generate acoustic waveforms 206 as well as tool waveforms 210. In examples, measurement assembly 134 may further comprise an isolator 212, which may operate and/or function to suppress tool waveforms 210 that propagate from transmitter 136 to receiver 137. In examples, isolator 212 may comprise cuts, grooves or cavities, which form structural discontinuity that attenuates/scatters tool waves. Therefore, as a result tool waves are suppressed. However, due to the limitation of the logging environment, the isolator may not fully remove tool waveforms 210, and thus receivers 137 may capture at least a part of tool waveforms 210. As material of casing 200 and measurement assembly 134 may be at least partially the same, arrivals times of casing waveforms 208 and tool waveforms 210 at receivers 137 may be close and may appear at the first echo of waveforms trains. Consequently, an amplitude log obtained from extracting the magnitude of the first echo comprise the contributions from both casing waveforms 208 and tool waveforms 210. Thus, the amplitude log may be corrected by removing tool waveforms 210 from the amplitude log.

Additionally, an amplitude log requires calibration by identifying zones fully bonded, at least partially bonded, and/or no bond between casing 200 and cement 202. Thus, those methods that rely on amplitude values may not work without human intervention, and even with intervention, it is possible to mis-identify such zones. Instead of using each individual amplitude values, a correlation may be utilized between the amplitude trend and the attenuation trend to iteratively update attenuation values. After obtaining attenuation values, bond indices may be directly inferred from real attenuation. Since the proposed method does not rely on individual amplitude values, it is suitable for LWD CBL without calibration.

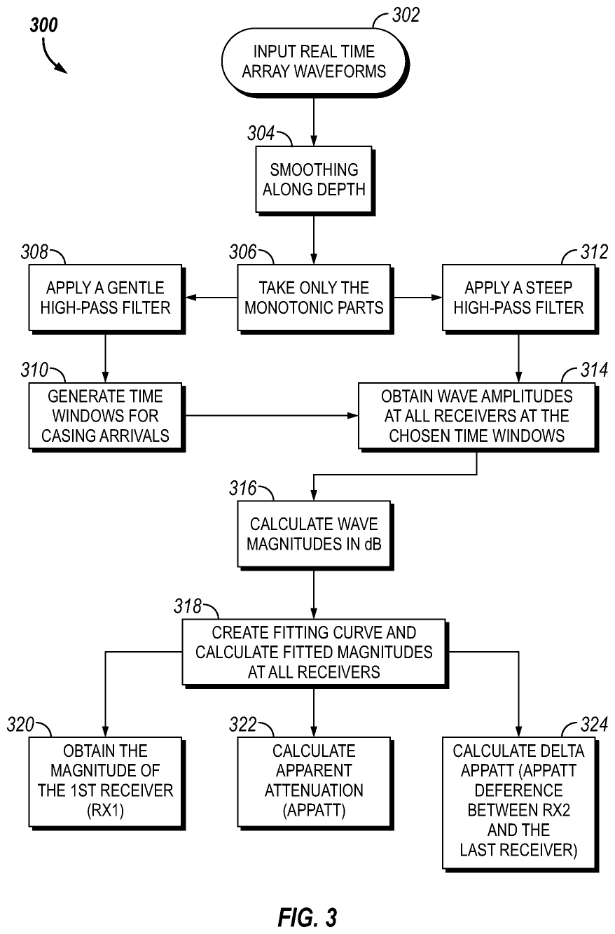

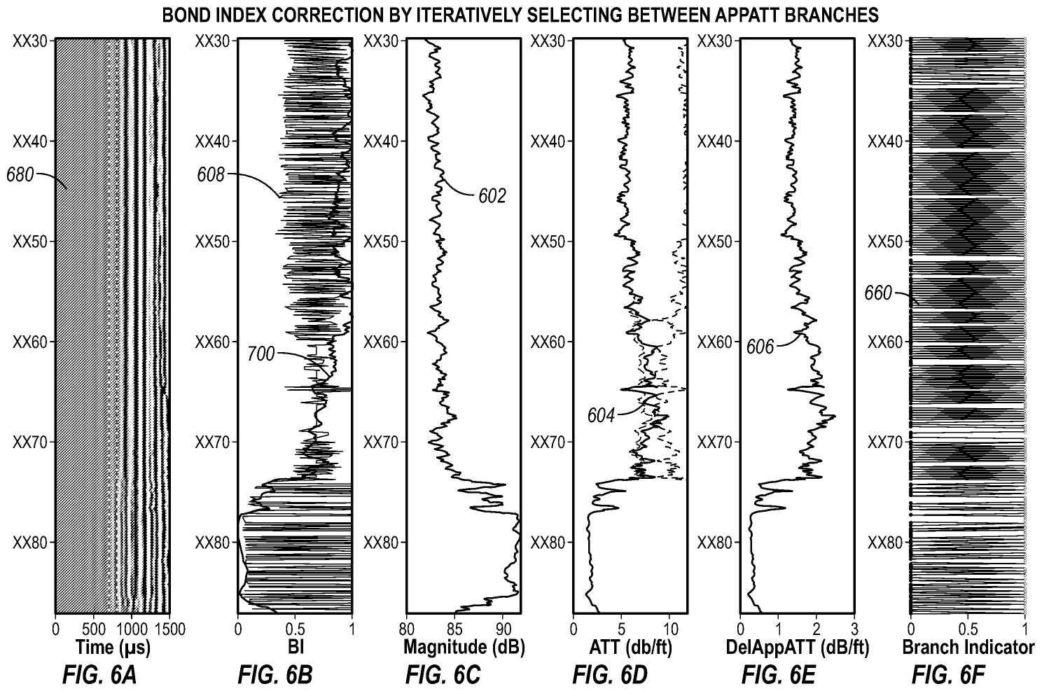

FIG. 3 illustrates a pre-processing workflow 300 may be performed at least in part on information handling system 138 (e.g., referring to FIG. 1) using the methods and systems described herein. The pre-processing workflow 300 may find one or more variables that may be utilized to form an iterative cement bond log, discussed below. Workflow 300 may start with block 302 in which casing waveforms 208 and tool waveforms 210 may be captured and/or measured by one or more receivers 137 (e.g., referring to FIG. 6), as described above. The captured and/or measured waveforms, which may also be referred to as data, from receivers 137 may be transmitted to information handling system 138 for further processing. In block 304, casing waveforms 208 (e.g., referring to FIG. 2) obtained from receivers 137 may be smoothened along depths by a moving window. Smoothing may comprise a smoothing filter implementing a window. The window may average the waveforms of 1-10 continuous depths. The range of the window size is from 5 to 15 empirically. However, a larger window size may be selected if logging speed is slow.

In block 306, casing waveforms 208 (e.g., referring to FIG. 2) that correspond to monotonically increasing depths may be chosen. This is to ensure that duplicates may be removed. In block 308, casing waveforms 208 may be passed through a gentle high-pass filter to filter low-frequency drilling noises. The high-pass filter with fewer taps may have its cut-off frequency between 1000 Hz and 4000 Hz to remove low-frequency noises and biases. In block 310, time windows may be generated at the filtered waveforms to capture first-echo arrivals at all receiver levels. The time window selection may be based on the travel time through tubing 200 and/or fluid 204 (e.g., referring to FIG. 2) or manually adjusted. The total travel time may be computed in the equation below.

total travel time=t₁+t₂+t₃ (1)

Herein, t₁ is the travel time of the oblique incident wave in fluid/mud from the transmitter to the casing surface, t₂ is the travel time of waves propagating along the casing, and t₃ is the travel time of the oblique reflected wave in fluid/mud from the casing back to receivers 137.

Referring back to block 306, in other examples, casing waveforms 208 may be passed through a steep high-pass filter with the cut-off frequency between 6000 Hz and 9000 Hz in block 312. This cut-off frequency is determined by the dominant frequency response of casing waveforms 208 and tool waveforms 210 arrivals. The purpose of the steep high-pass filter is to take advantage of the time-domain aliasing effect for mixing casing and tool wave arrivals. This mixing effect makes the summation model hold without the necessity of including phase factors.

In block 314, applying the time windows selected from the filtered waveforms filtered by the gentle filter to the waveforms filtered by the steep filter in block 312, a root-mean-squared amplitude at all receivers 137 in the time windows may be obtained. FIG. 6A illustrates an example of a root mean square amplitude 680 for a receiver 137. Referring back to FIG. 3, the amplitudes may comprise of both casing waveform 208 amplitudes and tool waveform 210 amplitudes. In block 316, the amplitudes may be converted to magnitudes in the unit of decibels (dB). For each acquisition there may be six magnitude values, one at each receiver level.

In block 316, the six magnitude values may be fit to a curve of a power law. The fitting curve may also take other forms such as relational and exponential. The fit magnitudes may create three variables to be utilized in further processing, discussed below. Blocks 320, 322, and 324 may be products of three downhole parameters. For example, in block 320, the downhole parameter of magnitude at the first receiver RX1 in dB may be conveyed, in block 322 the downhole parameter of apparent attenuation at the last receiver AppAtt in dB/ft may be conveyed, which is calculated from the magnitude difference between the last and the 1st receiver and then normalized by the corresponding receiver spacing, and in block 324 the downhole parameter of apparent attenuation difference between the 2nd and the last receiver delta AppAtt in dB/ft may be conveyed. The three downhole parameters, magnitude at the first receiver RX1, apparent attenuation at the last receiver AppAtt, and apparent attenuation difference between the 2nd and the last receiver delta AppAtt, may be inputs for further processing. Utilizing workflow 300, magnitude of the first receiver RX1 may be obtained in block 320, apparent attenuation at the last receiver AppAtt in block 322, and/or apparent difference between the second receiver 137 and the last receiver 137 apparent attenuation difference between the 2nd and the last receiver delta AppAtt in block 324. FIG. 6C illustrates magnitude at the first receiver RX1 as 602, FIG. 6D illustrates apparent attenuation at the last receiver AppAtt as 604, and FIG. 6E illustrates apparent attenuation difference between the 2nd and the last receiver delta AppAtt as 606. Another example of a downhole parameter may be real attenuation RealAtt. Two possible real attenuation RealAtt values inverted from the right and left branches of summation model, to be discussed below.

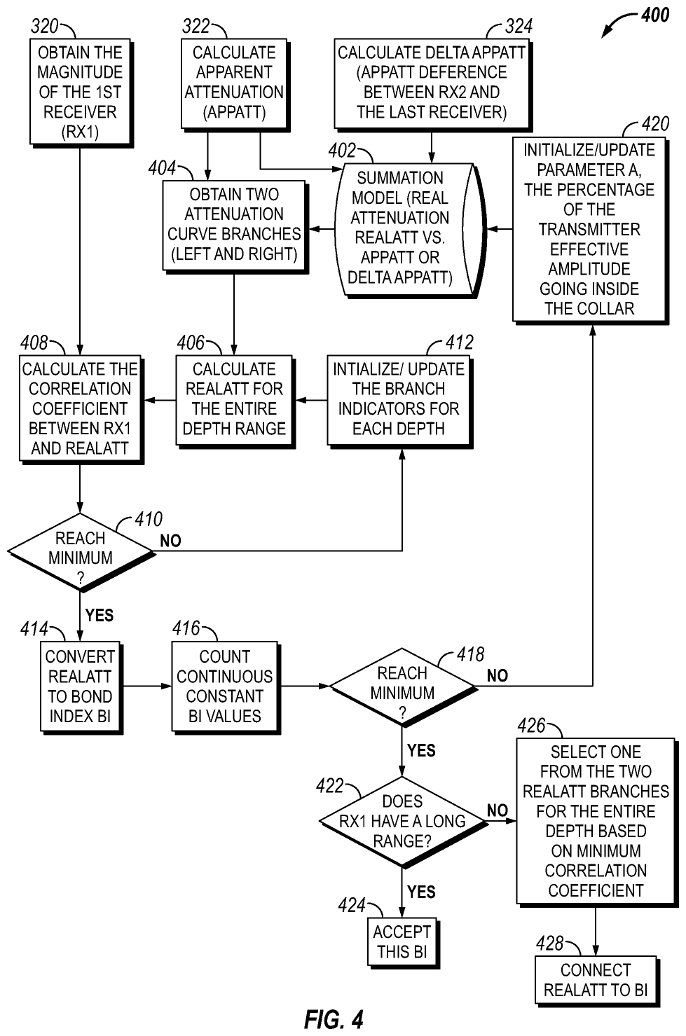

FIG. 4 illustrates workflow 400 for iterating a cement bond log (CBL), which may be performed at least in part on information handling system 138 (e.g., referring to FIG. 1) using the methods and systems described herein. As illustrated, workflow 400 may begin with two downhole parameters, described above in blocks 320, 322, 324, and/or real attenuation RealAtt values. A component of the main processing workflow requires calculating the correlation coefficient between two downhole parameters. There may be two or more strategies to calculate a correlation coefficient. The first strategy may be a correlation coefficient for the correlation between magnitude at the first receiver RX1 and the real attenuation RealAtt derived from apparent attenuation at the last receiver AppAtt. In the first strategy, the two downhole parameters implemented are magnitude at the first receiver RX1 and apparent attenuation at the last receiver AppAtt. The second strategy may be a correlation coefficient for the correlation between magnitude at the first receiver RX1 and real attenuation RealAtt. In strategy 1, real attenuation RealAtt may be derived from apparent attenuation difference between the 2nd and the last receiver delta AppAtt. In strategy 2, the two downhole parameters implemented may be magnitude at the first receiver RX1 and real attenuation RealAtt derived from apparent attenuation difference between the 2nd and the last receiver delta AppAtt. Different strategies require different summation models. In examples only block 322 and not block 324 may be performed in strategy 1, as discussed herein. However, only block 324 and not block 322 may be performed strategy in strategy 2, using workflow 400, as discussed herein.

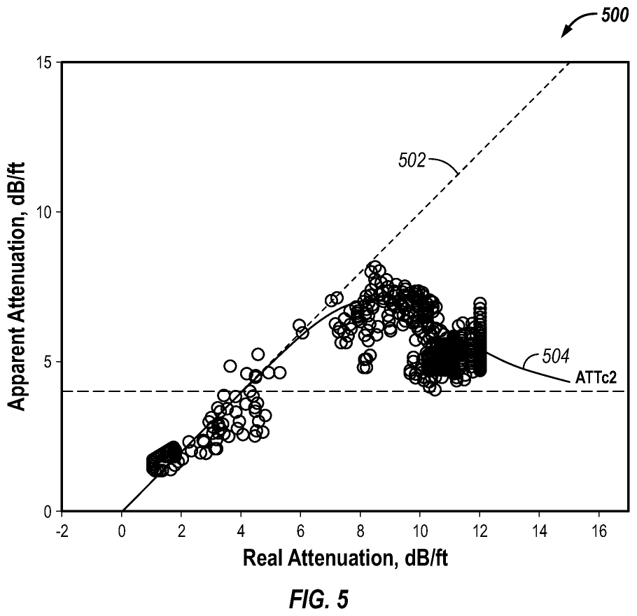

Workflow 400 illustrates strategy 1, however in examples, strategy 2 may be applied instead of strategy 1. In block 402, a summation model is created. FIG. 5 illustrates a graph that shows summation model 500 as a theoretical model forming a correlation between apparent attenuation at the last receiver AppAtt and real attenuation RealAtt may be referred to as a correlation. The model may comprise input parameters a, which is the percentage of the transmitter effective amplitude going inside the collar, ATTc2, which is the attenuation value in dB/ft at the receiver section, and/or minimum of real attenuation RealAtt, which is the real casing attenuation value in dB/ft for free pipes. Among these input parameters, ATTc2 may be pre-determined by tool types or sizes and minimum of real attenuation RealAtt may be pre-determined by casing sizes. For example, if tool sizes are large, ATTc2 will be large (˜4 dB/ft), if casing sizes are large, minimum of real attenuation RealAtt may be large (˜1 dB/ft). However, parameter a cannot be directly measured and it may vary even if tool sizes, and casing sizes do not change. This is because, for the same sized tool, isolator 212 (e.g., referring to FIG. 2) may be worn out, and consequently variable a may change. Thus, in block 404, the variable a may be chosen to create an exemplary summation model to use.

FIG. 5 illustrates summation model 500 used in block 404. Summation model 500 may be implemented for strategy 1 or strategy 2. As shown FIG. 5, summation model 500 for strategy 1. However, strategy 2 may also be employed. In examples, strategy 2 may implement apparent attenuation difference between the 2nd and the last receiver delta AppAtt along the y-axis rather than apparent attenuation at the last receiver AppAtt. In either example, summation model 500 may invert apparent attenuation at the last receiver AppAtt or apparent attenuation difference between the 2nd and the last receiver delta AppAtt from block 322 (e.g., referring to FIG. 3) into two possible real attenuation RealAtt values. In block 406, summation model 500 may invert apparent attenuation at the last receiver AppAtt or apparent attenuation difference between the 2nd and the last receiver delta AppAtt into real attenuation RealAtt at each depth for an entire depth range. The two possible real attenuation RealAtt values may be from right branch 504 and left branch 502. The inversion comprises summation model 500 which determines two possible real attenuation RealAtt with left branch 502 and right branch 504. To indicate which one of the two possible real attenuation RealAtt may be selected at each depth, a branch indicator may be implemented at each depth. A branch indicator may be a value 0 or 1 value corresponding to real attenuation RealAtt inverted from the right or left branches, respectively. For instance, FIG. 6F is a graph that illustrates initial branch indicator 660 for the entire depth range. The filtered waveforms from block 314 (e.g., referring to FIG. 3) may be illustrated in the graph of FIG. 6A. FIG. 6F illustrates an example initial branch indicator 660 that has random distribution. Based on the branch indicator, from the two possible real attenuation RealAtt at each depth, a single real attenuation RealAtt is chosen, and then the real attenuation RealAtt log may be formed for the entire depth range. In the branch indicator, 0 may indicate the right branch and 1 may indicate the left branch.

Referring back to FIG. 4 and workflow 400, after obtaining the real attenuation RealAtt log in block 406, in block 408 the correlation coefficient is calculated between magnitude at the first receiver RX1 and real attenuation RealAtt. The correlation coefficient ρ_{xy} may be calculated in equation (2).

$${ρ}_{RX 1 RealAtt} = \frac{Cov ( RX 1 , RealA tt )}{{σ}_{R X 1} {σ}_{RealAtt}} \qquad ( 2 )$$

Where Cov(RX1, RealAtt) is the covariance of variables magnitude at the first receiver RX1 and real attenuation RealAtt, σ_{RealAtt} is the standard deviation of real attenuation RealAtt, and σ_{RX1} is the standard deviation of magnitude at the first receiver RX1.

In block 410, it is determined if the correlation coefficient has reached minimum after it is calculated in block 408. Specifically, the correlation coefficient reaches minimum when it does not become less compared to its most previous iteration. For example, if the coefficient from the current iteration is equal to or greater than the correlation coefficient calculated from the previous iteration then, workflow 400 proceeds to block 414. Thus, if changing any branch (from left to right or right to left) indicator in the depth range, i.e., choosing the other value of real attenuation RealAtt, does not further make the correlation coefficient smaller, we regard the coefficient reaches minimum. If the coefficient is not minimized, a new iteration is performed. For a new iteration, in block 412 the branch indicator may be updated. The branch indicator may switch one or more indicators at one or more depths. In other examples, the branch indicator may only update one indicator at one depth for each iteration. For example, if the indicator value from the previous iteration is 0 at a depth, it may be switched to a value of 1 at that depth. In a new iteration, if the correlation coefficient reduces, then the indicator at that depth is saved as a 1 and is not updated in workflow 400. However, if switching the indicator value increases the correlation coefficient, it may be switched back and saved. The new iteration may continue to block 406 and block 408, as previously described. After a new correlation coefficient is determined in block 408 the new iteration proceeds to block 410. If the new correlation coefficient is not minimized, as previously described, an nth iteration may proceed with blocks 412, 406, 408, and 410 as previously described. During each iteration, all depths and branch indicator values may be reviewed and/or changed if the correlation coefficient may be reduced. As such, the branch indicator at each depth may be iteratively updated by depth until the correlation coefficient between magnitude at the first receiver RX1 and real attenuation RealAtt reaches minimum.

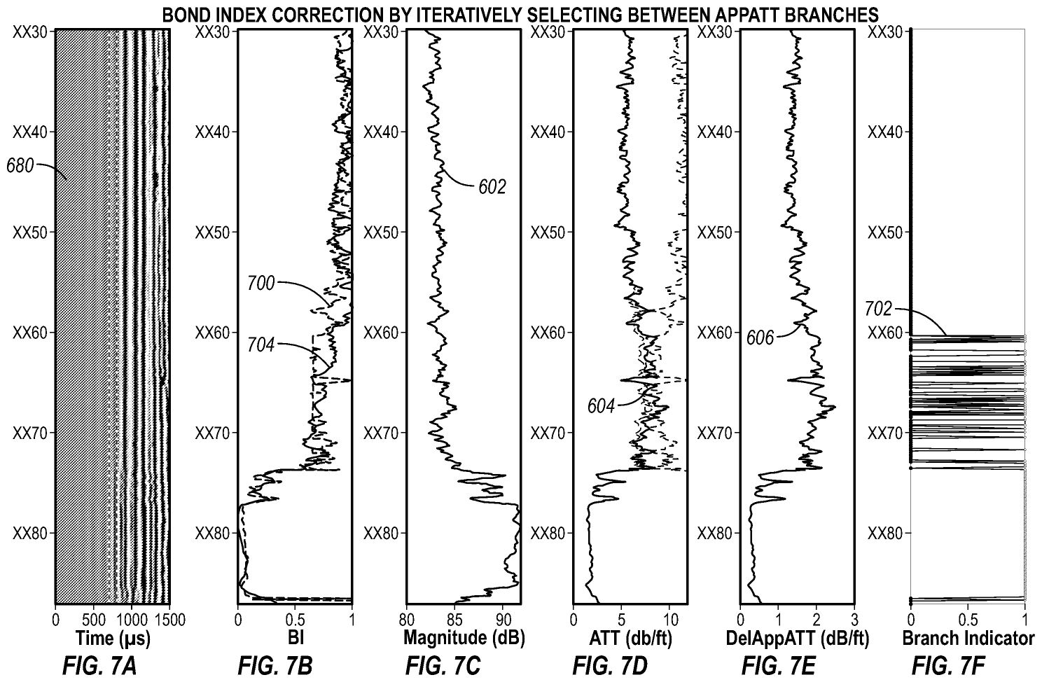

An example of the altered branch indicator may be shown in FIGS. 6F and 7F. As shown in FIG. 6F, an initial branch indicator 660 is updated after one or more iterations to form final branch indicator 702. As illustrated in FIG. 7F, the top part of the branch indicator indicates using real attenuation RealAtt derived from the right branch now, while the bottom indicates using real attenuation RealAtt derived from the left branch.

Referring back to FIG. 4, in block 414, the final real attenuation RealAtt log (not shown) from the last iteration of block 406 may be converted into cement bond indices by linear mapping. The linear mapping may linearly scale the range of minimum of real attenuation RealAtt and 12 dB/ft to the range of 0 and 1, where minimum of real attenuation RealAtt is the real attenuation of free pipes and 12 dB/ft is the usual real attenuation of full bonded zones. Using this scale, real attenuation RealAtt values may be converted to the values between 0 and 1, indicating bond indices. FIG. 6B illustrates real attenuation RealAtt log converted into a cement bond index 608 by linear mapping. This may not be a final solution, as illustrated in FIG. 6B, since the branch indicator is initialized randomly and the correlation coefficient does not reach minimum, the resultant bond indices jump frequently. In FIG. 6B, the blue curve is the benchmark from the wireline measurement for comparison. The red curve generated from the proposed workflow significantly differs from the benchmark blue curve, meaning at the initial state the workflow does not provide the correct answer due to the random branch indicators. After completing iterations, now in FIG. 7B, the bond index log shows the correct curve 700 in FIG. 7B, which has the trend opposite to the magnitude curve. The final bond index log 700 may bey close to the wireline benchmark value 704, validating the proposed workflow. However, all of the above demonstrations are based on the assumption that the parameter a of the summation model is known and properly selected. However, in examples, parameter a may not be known or directly measured.

In block 416, to obtain parameter a, global iterations may be used by minimizing the number of continuous constant bond indices in bond index logs. For each value of parameter, a, the count of continuous bond indices may be the same value. We further sweep the parameter a, and find the a that gives the minimum count of continuous bond indices of the same value. If parameter a is chosen too large, the calculated bond indices may have many continuous constant values between 0 and 1, and on the other hand, if parameter a is chosen too small, the bond indices will also have many continuous constant values but all equal to 1. This is due to the distinct mismatch between apparent attenuation at the last receiver AppAtt data distribution and the summation model curve 500 (e.g., referring to FIG. 5). A properly selected parameter a may make apparent attenuation at the last receiver AppAtt data distribution and summation model curve 500, resulting in a reasonable and varying bond index curve. Therefore, in the main processing workflow, after obtaining bond index logs for a given initial parameter a, the parameter a may be iterated in the range of 0.01-0.2 to minimize the number of continuous constant bond indices. In block 418, when the number of continuous constant bond indices reaches minimum, the optimized parameter a and the corresponding bond index log are thus obtained, which may be used to update parameter a in block 420.

In block 422 it may be determined whether the resultant optimized bond indices may be utilized based on the dynamic range of magnitude at the first receiver RX1. Generally, a smaller dynamic range of magnitude at the first receiver RX1 may incur less reliable correlation calculation, especially when noises are involved. Thus, in block 422, it is determined if the magnitude at the first receiver RX1 range is too small, (e.g., smaller than 5 dB). If the magnitude at the first receiver RX1 range is too small in block 426, identical branch indicator values may be utilized for all depths. In such case, branch indicators may be ignored along the depth, and only choose the same branch indicator for all depths. Which branch to choose depends on which branch gives the real attenuation RealAtt that leads to the smaller correlation coefficient. In block 828 the selected branch may be converted to real attenuation RealAtt to bond indices. If the range of magnitude at the first receiver RX1 is too large, in block 424 the bond indices are accepted.

FIG. 7A illustrates an example of a root mean square amplitude 680 (e.g., referring to FIG. 6A) for a receiver 137 (e.g., referring to FIG. 1). FIG. 7C illustrates magnitude at the first receiver RX1 as 602 (e.g., referring to FIG. 6C). FIG. 7D illustrates apparent attenuation at the last receiver AppAtt 604 (e.g., referring to FIG. 6D). FIG. 7E illustrates apparent attenuation difference between the 2nd and the last receiver delta AppAtt 606 (e.g., referring to FIG. 7E).

Workflows 300 and 400 may utilize a log from magnitude at the first receiver RX1, which is the magnitude at a 1st receiver 137 (e.g., referring to FIG. 1). However, it may only make use of the changing trend of magnitude at the first receiver RX1. In detail, the correlation coefficient indicates whether magnitude at the first receiver RX1 and real attenuation RealAtt have the same trend of change or the opposite trend, and therefore one single magnitude value at an acquisition is not meaningful. As workflows 300 and 400 do not rely on each individual magnitude values, amplitude calibration is not required. As previously described, receiver 137 may be a component of BHA 130 and communicatively coupled with information handling system 138.

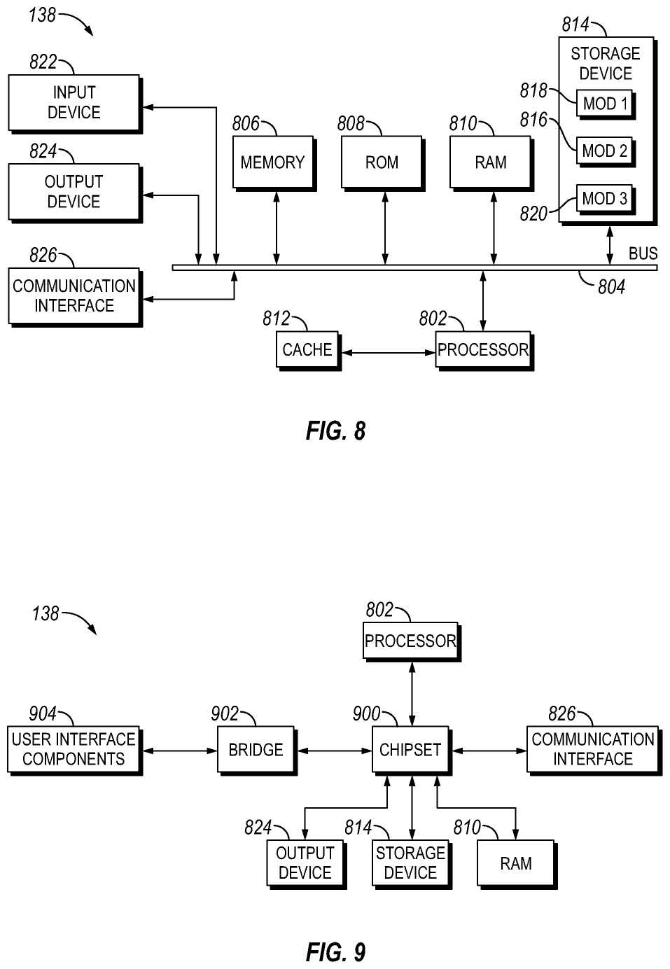

FIG. 8 illustrates an example information handling system 138 which may be employed to perform various steps, methods, and techniques disclosed herein. Persons of ordinary skill in the art will readily appreciate that other system examples are possible. As illustrated, information handling system 138 includes a processing unit (CPU or processor) 802 and a system bus 804 that couples various system components including system memory 806 such as read only memory (ROM) 808 and random-access memory (RAM) 810 to processor 802. Processors disclosed herein may all be forms of this processor 802. Information handling system 138 may include a cache 812 of high-speed memory connected directly with, in close proximity to, or integrated as part of processor 802. Information handling system 138 copies data from memory 806 and/or storage device 814 to cache 812 for quick access by processor 802. In this way, cache 812 provides a performance boost that avoids processor 802 delays while waiting for data. These and other modules may control or be configured to control processor 802 to perform various operations or actions. Another system memory 806 may be available for use as well. Memory 806 may include multiple different types of memory with different performance characteristics. It may be appreciated that the disclosure may operate on information handling system 138 with more than one processor 802 or on a group or cluster of computing devices networked together to provide greater processing capability. Processor 802 may include any general-purpose processor and a hardware module or software module, such as first module 816, second module 218, and third module 820 stored in storage device 814, configured to control processor 208 as well as a special-purpose processor where software instructions are incorporated into processor 802. Processor 802 may be a self-contained computing system, containing multiple cores or processors, a bus, memory controller, cache, etc. A multi-core processor may be symmetric or asymmetric. Processor 802 may include multiple processors, such as a system having multiple, physically separate processors in different sockets, or a system having multiple processor cores on a single physical chip. Similarly, processor 802 may include multiple distributed processors located in multiple separate computing devices but working together such as via a communications network. Multiple processors or processor cores may share resources such as memory 806 or cache 812 or may operate using independent resources. Processor 802 may include one or more state machines, an application specific integrated circuit (ASIC), or a programmable gate array (PGA) including a field PGA (FPGA).

Each individual component discussed above may be coupled to system bus 804, which may connect each and every individual component to each other. System bus 804 may be any of several types of bus structures including a memory bus or memory controller, a peripheral bus, and a local bus using any of a variety of bus architectures. A basic input/output (BIOS) stored in ROM 808 or the like, may provide the basic routine that helps to transfer information between elements within information handling system 138, such as during start-up. Information handling system 138 further includes storage devices 814 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 814 may include software modules 816, 818, and 820 for controlling processor 802. Information handling system 138 may include other hardware or software modules. Storage device 814 is connected to the system bus 804 by a drive interface. The drives and the associated computer-readable storage devices provide nonvolatile storage of computer-readable instructions, data structures, program modules and other data for information handling system 138. In one aspect, a hardware module that performs a particular function includes the software component stored in a tangible computer-readable storage device in connection with the necessary hardware components, such as processor 802, system bus 804, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 138 is a small, handheld computing device, a desktop computer, or a computer server. When processor 802 executes instructions to perform “operations”, processor 802 may perform the operations directly and/or facilitate, direct, or cooperate with another device or component to perform the operations.

As illustrated, information handling system 138 employs storage device 814, which may be a hard disk or other types of computer-readable storage devices which may store data that are accessible by a computer, such as magnetic cassettes, flash memory cards, digital versatile disks (DVDs), cartridges, random access memories (RAMs) 810, read only memory (ROM) 808, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 138, an input device 822 represents any number of input mechanisms, such as a microphone for speech, a touch-sensitive screen for gesture or graphical input, keyboard, mouse, motion input, speech and so forth. Additionally, input device 822 may take in data from measurement assembly 134, discussed above. An output device 824 may also be one or more of a number of output mechanisms known to those of skill in the art. In some instances, multimodal systems enable a user to provide multiple types of input to communicate with information handling system 138. Communications interface 826 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 802, that is purpose-built to operate as an equivalent to software executing on a general-purpose processor. For example, the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 808 for storing software performing the operations described below, and random-access memory (RAM) 810 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 138 may practice all or part of the recited methods, may be a part of the recited systems, and/or may operate according to instructions in the recited tangible computer-readable storage devices. Such logical operations may be implemented as modules configured to control processor 802 to perform particular functions according to the programming of software modules 816, 818, and 820.

In examples, one or more parts of the example information handling system 138, up to and including the entire information handling system 138, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may include one or more virtual machines, an overlay network, a hypervisor, virtual switching, and any other virtualization application.

FIG. 9 illustrates an example information handling system 138 having a chipset architecture that may be used in executing the described method and generating and displaying a graphical user interface (GUI). Information handling system 138 is an example of computer hardware, software, and firmware that may be used to implement the disclosed technology. Information handling system 138 may include a processor 802, representative of any number of physically and/or logically distinct resources capable of executing software, firmware, and hardware configured to perform identified computations. Processor 802 may communicate with a chipset 900 that may control input to and output from processor 802. In this example, chipset 900 outputs information to output device 824, such as a display, and may read and write information to storage device 814, which may include, for example, magnetic media, and solid-state media. Chipset 900 may also read data from and write data to RAM 810. Bridge 902 for interfacing with a variety of user interface components 904 may be provided for interfacing with chipset 900. User interface components 904 may include a keyboard, a microphone, touch detection and processing circuitry, a pointing device, such as a mouse, and so on. In general, inputs to information handling system 138 may come from any of a variety of sources, machine generated and/or human generated.

Chipset 900 may also interface with one or more communication interfaces 826 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 802 analyzing data stored in storage device 814 or RAM 810. Further, information handling system 138 receives inputs from a user via user interface components 904 and executes appropriate functions, such as browsing functions by interpreting these inputs using processor 802.

In examples, information handling system 138 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

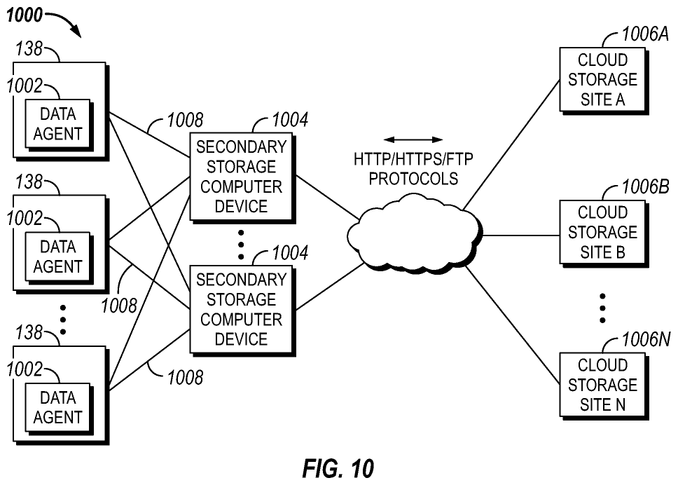

FIG. 10 illustrates an example of one arrangement of resources in a computing network 1000 that may employ the processes and techniques described herein, although many others are of course possible. As noted above, an information handling system 138, as part of their function, may utilize data, which includes files, directories, metadata (e.g., access control list (ACLS) creation/edit dates associated with the data, etc.), and other data objects. The data on the information handling system 138 is typically a primary copy (e.g., a production copy). During a copy, backup, archive or other storage operation, information handling system 138 may send a copy of some data objects (or some components thereof) to a secondary storage computing device 1004 by utilizing one or more data agents 1002.

A data agent 1002 may be a desktop application, website application, or any software-based application that is run on information handling system 138. As illustrated, information handling system 138 may be disposed at any rig site (e.g., referring to FIG. 1) or repair and manufacturing center. Data agent 1002 may communicate with a secondary storage computing device 1004 using communication protocol 1008 in a wired or wireless system. Communication protocol 1008 may function and operate as an input to a website application. In the website application, field data related to pre- and post-operations, generated DTCs, notes, and the like may be uploaded. Additionally, information handling system 138 may utilize communication protocol 1008 to access processed measurements, operations with similar DTCs, troubleshooting findings, historical run data, and/or the like. This information is accessed from secondary storage computing device 1004 by data agent 1002, which is loaded on information handling system 138.

Secondary storage computing device 1004 may operate and function to create secondary copies of primary data objects (or some components thereof) in various cloud storage sites 1006A-N. Additionally, secondary storage computing device 1004 may run determinative algorithms on data uploaded from one or more information handling systems 138, discussed further below. Communications between the secondary storage computing devices 1004 and cloud storage sites 1006A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 1006A-N, the secondary storage computing device 1004 may also perform local content indexing and/or local object-level, sub-object-level or block-level deduplication when performing storage operations involving various cloud storage sites 1006A-N. Cloud storage sites 1006A-N may further record and maintain DTC code logs for each downhole operation or run, map DTC codes, store repair and maintenance data, store operational data, and/or provide outputs from determinative algorithms that are fun at cloud storage sites 1006A-N.

The methods and systems described above are improvements over current technology. For example, due to the existence of tool waveforms, conventional cement bonding log (CBL) methods for LWD sonic data might yield biased CBL amplitudes, and thus generate large errors in estimating bonding indices compared to the results from a wireline sonic tool. These errors might affect determining bonding condition of zones. Previous methods depending on each individual amplitude values of first echoes only accurately estimate bond indices after calibration by identifying 100% bond zones or free-pipe zones. However, sometimes these may be mis-identified or such zones may not be identified. Consequently, previous methods cannot work without calibration and human intervention. The systems and methods described above propose automated processing for iterative CBL using an LWD tool. This new processing utilizes the trend of amplitude log change instead of each individual amplitude values, and thus is ideal for the processing where it may not be possible to calibrate amplitude logs. Furthermore, unknown parameters, such as the branch indicators and the model parameter a, are iteratively updated to achieve reasonable cement bond indices, without human intervention. Using field data disclosed above, it has been demonstrated that measured attenuation may be corrected to reflect the true nature of casing wave amplitude decrease. The corrected attenuation is used to calculate bond indices, which match well with the benchmark results. This invented iterative LWD CBL method enables quantitative cement bond logging without calibration and human intervention and is applicable to post-processing LWD CBL as well as inside and real-time processing if updates of entire CBL logs are permitted.

The systems and methods for using a distributed acoustic system in a subsea environment may include any of the various features of the systems and methods disclosed herein, including one or more of the following statements. Additionally, the systems and methods for an acoustic tool in a downhole environment may include any of the various features of the systems and methods disclosed herein, including one or more of the following statements.

Statement 1: A method comprising: disposing a bottom hole assembly (BHA) into a wellbore at a depth, wherein the BHA comprises: at least one transmitter configured to transmit an acoustic waveform into at least a casing; and at least one receiver configured to record one or more casing waveforms that originate from within or behind the casing; calculate at least two or more downhole parameters with the one or more casing waveforms; calculating a correlation coefficient between the at least two or more downhole parameters; and forming a cement bond log based at least in part on the correlation coefficient.

Statement 2: The method of statement 1, wherein the two or more downhole parameters are an apparent attenuation and a magnitude of a first receiver from the one or more receivers.

Statement 3: The method of statement 2, further comprising inverting apparent attenuation in a summation model to form a first possible real attenuation and a second possible real attenuation at the depth.

Statement 4: The method of statement 3, wherein a branch indicator selects between the first possible real attenuation and the second possible real attenuation to determine a real attenuation.

Statement 5: The method of statement 4, wherein the branch indicator selects first possible real attenuation if the branch indicator is a left branch and selects second possible real attenuation if the branch indicator is a right branch.

Statement 6: The method of statement 5, wherein the branch indicator is initially randomly distributed between left branches and right branches. Statement 7: The method of statements 4-6, wherein the correlation coefficient is calculated by:

$${ρ}_{RX 1 RealAtt} = \frac{Cov ( RX 1 , RealA tt )}{{σ}_{R X 1} {σ}_{RealAtt}}$$

wherein, RX1 is the magnitude of the first receiver, RealAtt is the real attenuation, ρ_{RX1 RealAtt} is the correlation coefficient, Cov(RX1,RealAtt) is the covariance of variables RX1 and RealAtt, ρ_{RX1} is the is the standard deviation of the magnitude of the first receiver, and ρ_{RealAtt} is the is the standard deviation of the real attenuation.

Statement 8: The method of statements 4-7, further comprising determining if the correlation coefficient is minimized by comparing it to a previous correlation coefficient from a previous iteration.

Statement 9: The method of statement 8, further comprising updating the branch indicator if the correlation coefficient is not minimized.

Statement 10: The method of statement 9, wherein updating the branch indicator comprises updating one or more indicators at one or more depths.

Statement 11: A system comprising: a bottom hole assembly (BHA) disposed into a wellbore at a depth, wherein the BHA comprises: at least one transmitter configured to transmit an acoustic waveform into at least a casing; and at least one receiver configured to record one or more casing waveforms from within or behind the casing; and an information handling system, wherein the information handling system is configured to: calculate at least two or more downhole parameters with the one or more casing waveforms; calculate a correlation coefficient between the at least two or more downhole parameters; and form a cement bond log based at least in part on the correlation coefficient.

Statement 12: The system of statement 11, wherein the two or more downhole parameters are an apparent attenuation and a magnitude of a first receiver from the one or more receivers.

Statement 13: The system of statement 12, wherein the information handling system is further configured to invert apparent attenuation in a summation model to form a first possible real attenuation and a second possible real attenuation at the depth.

Statement 14: The system of statement 13, wherein a branch indicator selects between the first possible real attenuation and the second possible real attenuation to determine a real attenuation.

Statement 15: The system of statement 14, wherein the branch indicator selects first possible real attenuation if the branch indicator is a left branch and selects second possible real attenuation if the branch indicator is a right branch.

Statement 16: The system of statement 15, wherein the branch indicator is initially randomly distributed between left branches and right branches.

Statement 17: The system of statements 14-16, wherein the information handling system is configured to calculate the correlation coefficient using:

$${ρ}_{RX 1 RealAtt} = \frac{Cov ( RX 1 , RealA tt )}{{σ}_{R X 1} {σ}_{RealAtt}}$$

wherein, RX1 is the magnitude of the first receiver, RealAtt is the real attenuation, ρ_{RX1 RealAtt} is the correlation coefficient, Cov(RX1, RealAtt) is the covariance of variables RX1 and RealAtt, σ_{RX1} is the is the standard deviation of the magnitude of the first receiver, and σ_{RealAtt} is the is the standard deviation of the real attenuation.

Statement 18: The system of statements 14-17, wherein the information handling system is further configured to determine if the correlation coefficient is minimized by comparing it to a previous correlation coefficient from a previous iteration.

Statement 19: The system of statement 18, wherein the information handling system is further configured to update the branch indicator if the correlation coefficient is not minimized.

Statement 20: The system of statement 19, wherein the update to the branch indicator comprises updating one or more indicators at one or more depths.

The preceding description provides various embodiments of systems and methods of use which may contain different method steps and alternative combinations of components.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a bottom hole assembly (BHA) into a wellbore at a depth, wherein the BHA comprises:
at least one transmitter configured to transmit an acoustic waveform into at least a casing; and
at least one receiver configured to record one or more casing waveforms that originate from within or behind the casing;
calculate at least two or more downhole parameters with the one or more casing waveforms;
calculating a correlation coefficient between the at least two or more downhole parameters; and
forming a cement bond log based at least in part on the correlation coefficient.

2. The method of claim 1, wherein the two or more downhole parameters are an apparent attenuation and a magnitude of a first receiver from the one or more receivers.

3. The method of claim 2, further comprising inverting apparent attenuation in a summation model to form a first possible real attenuation and a second possible real attenuation at the depth.

4. The method of claim 3, wherein a branch indicator selects between the first possible real attenuation and the second possible real attenuation to determine a real attenuation.

5. The method of claim 4, wherein the branch indicator selects first possible real attenuation if the branch indicator is a left branch and selects second possible real attenuation if the branch indicator is a right branch.

6. The method of claim 5, wherein the branch indicator is initially randomly distributed between left branches and right branches.

7. The method of claim 4, wherein the correlation coefficient is calculated by:
$${ρ}_{RX 1 RealAtt} = \frac{Cov ( RX 1 , RealA tt )}{{σ}_{R X 1} {σ}_{RealAtt}}$$
wherein, RX1 is the magnitude of the first receiver, RealAtt is the real attenuation, σ_{RX1 RealAtt} is the correlation coefficient, Cov(RX1, RealAtt) is the covariance of variables RX1 and RealAtt, ρ_{RX1} is the is the standard deviation of the magnitude of the first receiver, and ρ_{RealAtt} is the is the standard deviation of the real attenuation.

8. The method of claim 4, further comprising determining if the correlation coefficient is minimized by comparing it to a previous correlation coefficient from a previous iteration.

9. The method of claim 8, further comprising updating the branch indicator if the correlation coefficient is not minimized.

10. The method of claim 9, wherein updating the branch indicator comprises updating one or more indicators at one or more depths.

11. A system comprising:
a bottom hole assembly (BHA) disposed into a wellbore at a depth, wherein the BHA comprises:
at least one transmitter configured to transmit an acoustic waveform into at least a casing; and
at least one receiver configured to record one or more casing waveforms from within or behind the casing; and
an information handling system, wherein the information handling system is configured to:
calculate at least two or more downhole parameters with the one or more casing waveforms;
calculate a correlation coefficient between the at least two or more downhole parameters; and
form a cement bond log based at least in part on the correlation coefficient.

12. The system of claim 11, wherein the two or more downhole parameters are an apparent attenuation and a magnitude of a first receiver from the one or more receivers.

13. The system of claim 12, wherein the information handling system is further configured to invert apparent attenuation in a summation model to form a first possible real attenuation and a second possible real attenuation at the depth.

14. The system of claim 13, wherein a branch indicator selects between the first possible real attenuation and the second possible real attenuation to determine a real attenuation.

15. The system of claim 14, wherein the branch indicator selects first possible real attenuation if the branch indicator is a left branch and selects second possible real attenuation if the branch indicator is a right branch.

16. The system of claim 15, wherein the branch indicator is initially randomly distributed between left branches and right branches.

17. The system of claim 14, wherein the information handling system is configured to calculate the correlation coefficient using:
$${ρ}_{RX 1 RealAtt} = \frac{Cov ( RX 1 , RealA tt )}{{σ}_{R X 1} {σ}_{RealAtt}}$$
wherein, RX1 is the magnitude of the first receiver, RealAtt is the real attenuation, ρ_{RX1 RealAtt} is the correlation coefficient, Cov(RX1, RealAtt) is the covariance of variables RX1 and RealAtt, σ_{RX1} is the is the standard deviation of the magnitude of the first receiver, and σ_{RealAtt} is the is the standard deviation of the real attenuation.

18. The system of claim 14, wherein the information handling system is further configured to determine if the correlation coefficient is minimized by comparing it to a previous correlation coefficient from a previous iteration.

19. The system of claim 18, wherein the information handling system is further configured to update the branch indicator if the correlation coefficient is not minimized.

20. The system of claim 19, wherein the update to the branch indicator comprises updating one or more indicators at one or more depths.
